(19) United States
(12) Patent Application Publication
(10) Pub. No.: US 2016/0326934 A1
(43) Pub. Date: Nov. 10, 2016

(54) CONTROL METHOD FOR INFORMING A DRIVER WHEN TO CLEAN DIESEL PARTICULATE FILTER

(71) Applicant: HYUNDAI MOTOR COMPANY, Seoul (KR)

(72) Inventor: Chang Dae KIM, Yongin-si (KR)

(73) Assignee: HYUNDAI MOTOR COMPANY, Seoul (KR)

(21) Appl. No.: 14/882,182

(22) Filed: Oct. 13, 2015

(30) Foreign Application Priority Data
May 8, 2015 (KR) 10-2015-0064406

(51) Int. Cl. F01N 9/00; F01N 3/021; B60Q 9/00; F01N 11/00

(52) U.S. Cl. CPC F01N 9/002; F01N 11/002; F01N 3/021; B60Q 9/00; F01N 2900/1611; F01N 2900/102; F01N 2560/08; F01N 2900/08; F01N 2900/1406

(57) ABSTRACT

The present disclosure provides a control method for informing a driver when to clean a diesel particulate filter (DPF). The control method for informing a driver when to clean a diesel particulate filter may include informing a driver of the time when to clean the DPF by operating a warning device depending on at least one of a differential pressure of the DPF and engine oil consumption.

### CROSS-REFERENCE TO RELATED APPLICATION

The present application claims the benefit of Korean Patent Application No. 10-2015-0064406, filed May 8, 2015, which is incorporated herein by reference in its entirety.

### FIELD

The present disclosure relates to a control method for informing a driver of the optimal time for cleaning a diesel particulate filter.

### BACKGROUND

The statements in this section merely provide background information related to the present disclosure and may not constitute prior art.

A diesel engine used for a diesel vehicle is required to satisfy various regulations and standards. One of the standards is reducing pollutants such as NOₓ, particulate matter (PM), and the like, included in exhaust gases.

To comply with such an environmental standard, an exhaust emission control device is installed in the diesel vehicle. The exhaust emission control device is generally configured by a DOC (Diesel Oxidation Catalyst)—DPF (Diesel Particulate Filter)—SCR (Selective Catalytic Reduction) system.

In this configuration, the diesel particulate filter (hereinafter, referred to as DPF) is disposed in a path through which exhaust gases are emitted from a diesel engine, for example, in an exhaust silencer, and the DPF indicates a filter capable of accumulating particulate matter such as soot and ash to be filtered. However, when the amount of the accumulated particulate matter exceeds a certain level, the back pressure is increased and filtering performance is decreased.

Here, soot can usually be removed by DPF regeneration, but ash is removed only through a physical cleaning method.

The conventional arts use a control method in which cleaning ash from a DPF is performed according to mileage of a vehicle. However, we have discovered that, when a vehicle is used in adverse driving conditions, DPF cleaning may be required though the mileage does not reach a certain level.

We have also discovered that, because the ingredient of a product added in engine oil is very similar to the ingredient of ash, when oil additives are used, the accumulated rate of ash may increase. Therefore, even though the mileage does not reach a certain level, DPF cleaning may be required. In other words, the determination of the time for cleaning the DPF based on the mileage may be inaccurate.

### SUMMARY

The present disclosure provides a control method for determining the time to clean a DPF based on the differential pressure of the DPF or engine oil consumption, and for outputting a warning signal depending on the determination.

According to the present disclosure, the control method informs a driver of a time to clean a DPF by operating a warning device based on at least one of a differential pressure of the DPF and engine oil consumption.

The method may include: measuring at least one between the differential pressure of the DPF and the engine oil consumption; and operating the warning device depending on at least one of the differential pressure of the DPF and the engine oil consumption.

The differential pressure of the DPF is measured when regeneration of the DPF is completed.

The step for operating the warning device may include determining whether the differential pressure is equal to or greater than a predetermined differential pressure when the differential pressure of the DPF is measured, and when the differential pressure of the DPF is equal to or greater than the predetermined differential pressure, the warning device is operated.

The predetermined differential pressure may be set to a value of a differential pressure when ash is accumulated to approximately 30% of a volume of the DPF channel.

The step for operating the warning device may include: calculating an amount of generated ash depending on the engine oil consumption when the engine oil consumption is measured; and comparing the amount of the generated ash with a predetermined value, and when the amount of the generated ash is equal to or greater than the predetermined value, the warning device is operated.

The predetermined value may be set to the amount of the generated ash when the ash is accumulated to approximately 30% of a volume of the DPF channel.

The warning device may be at least one between a display device and an alarm device.

According to a control method for informing a driver when to clean a diesel particulate filter configured as the above description, because the time when to clean a DPF is determined depending on the accumulated amount of ash, which is calculated based on the differential pressure of the DPF or engine oil consumption, the time when to clean the DPF is accurately determined regardless of a driver's driving style, driving conditions, and age of a vehicle.

Also, because the time when to clean the DPF is set to time when the accumulated amount of the ash is greater than approximately 30% of the volume of the DPF channel, the back pressure of the DPF is prevented from being increased to a level at which the prescribed power and performance of the engine may not be output, whereby the fuel efficiency is improved and the damage of the DPF is prevented. Also, by informing a driver of the time when to clean the DPF, the driver may easily clean the DPF or replace the DPF, thus reducing the time for repairing the DPF.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a control device for informing a driver when to clean a diesel particulate filter, according to an embodiment of the present disclosure; and

FIG. 2 is a flowchart illustrating a control method for informing a driver when to clean a diesel particulate filter, according to an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

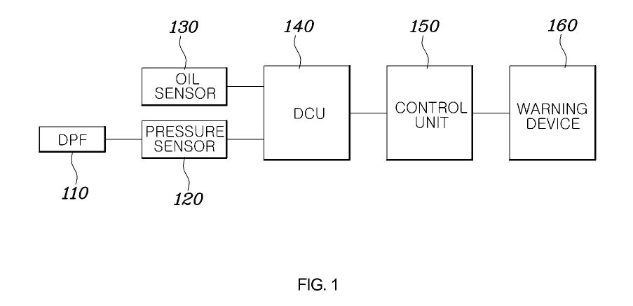

FIG. 1 is a block diagram illustrating a control device for informing a time when to clean a diesel particulate filter, according to an embodiment of the present disclosure. Referring to FIG. 1, a control device for informing a driver when to clean a diesel particulate filter may include: a dosing control unit 140 (hereinafter, referred to as DCU) for outputting at least one of a differential pressure information measured by a pressure sensor 120 and an engine oil consumption information measured by an oil sensor 130; and a control unit 150 for operating a warning device 160 based on the at least one of the information (i.e., the differential pressure information of the DPF 110 and the engine oil consumption information, received from the DCU).

The operation and control method of the control device for informing a driver when to clean a DPF will be described in detail later.

Hereinafter, a control method for informing a driver when to clean a diesel particulate filter according to an embodiment of the present disclosure is described with reference to the accompanying drawing.

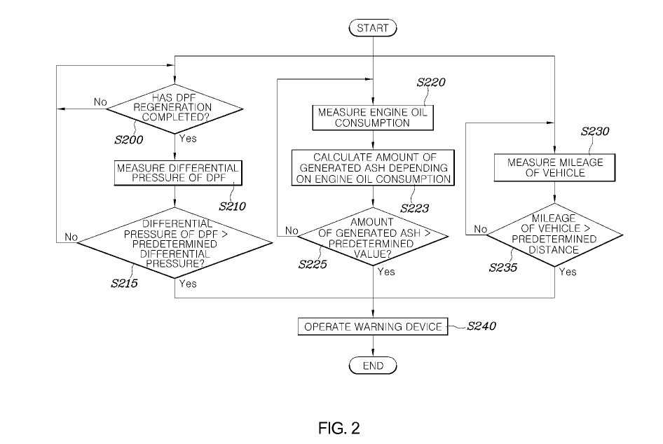

FIG. 2 is a flowchart illustrating a control method for informing a driver when to clean a diesel particulate filter, according to an embodiment of the present disclosure. Referring to FIG. 2, the control method for informing a driver when to clean a diesel particulate filter includes integrated control logic that informs a driver of the time to clean a DPF by operating a warning device 160 based on at least one of the differential pressure of the DPF 110 and the engine oil consumption.

The integrated control logic includes steps for measuring at least one of the differential pressure of the DPF and the engine oil consumption (S210, S220), and a step for operating the warning device 160 depending on the at least one information (i.e., the differential pressure of the DPF and the engine oil consumption) (S240).

Specifically, the DPF 110 has a characteristic that the back pressure increases the amount of ash accumulated in the DPF. Therefore, as the differential pressure of the DPF 110 increases, the accumulated amount of ash increases and the time when to clean the DPF 110 may be advanced. Accordingly, the control unit 150 may inform the driver when to clean the DPF 110 by operating the warning device 160 depending on the differential pressure of the DPF 110.

Also, when a metallic additive is added to the engine oil, the time when to clean the DPF 110 may be advanced. This is because the ingredient of the ash accumulated in the DPF 110 is similar to the main ingredients of the metallic additive. Therefore, the control unit 150 may inform the driver when to clean the DPF 110 by operating the warning device 160 depending on the consumption of engine oil in which the metallic additive is added.

Because the above-mentioned method for determining when to clean the DPF 110, which is based on the differential pressure of the DPF 110 and the engine oil consumption, is a method for determining when to clean the DPF 110 depending on the amount of the ash accumulated in the DPF 110, it may accurately determine when to clean the DPF 110 regardless of the driving pattern of the driver, an external environment, and a driving condition.

The information about the differential pressure of the DPF 110 or the engine oil consumption information is transmitted from the DCU 140 to the control unit 150, and the control unit 150 may determine whether to operate the warning device 160 depending on the differential pressure of the DPF 110 or the engine oil consumption. Here, the DCU 140 receives the information of the differential pressure of the DPF 110 from the pressure sensor 120, which measures the difference between pressures before and after the DPF 110, and the engine oil consumption information from the oil sensor 130, and may transmit the pieces of information to the control unit 150.

The differential pressure of the DPF 110 is measured when the regeneration of the DPF 110 has been completed. If the differential pressure of the DPF 110 is measured under the condition that the regeneration of the DPF 110 has not been completed, because not only the ash but also the volume of soot, which may be removed during the regeneration, are measured, the accurate time when to clean the DPF 110 may not be diagnosed. Therefore, by measuring the differential pressure of the DPF 110 when the regeneration of the DPF 110 has been completed and the soot has been removed, the time when to clean the DPF 110 may be accurately diagnosed.

The step for operating the warning device (S240) further includes comparing the differential pressure of the DPF 110 with a predetermined differential pressure (S215) when the differential pressure of the DPF 110 is measured, and is configured to operate the warning device 160 when the differential pressure of the DPF is equal to or greater than the predetermined differential pressure.

For example, after the regeneration of the DPF 110 has been completed, when the differential pressure of the DPF is measured, the differential pressure is compared with the predetermined differential pressure (S215). Then, when the differential pressure of the DPF is greater than the predetermined differential pressure, it is determined that more than a certain amount of ash is accumulated inside the DPF 110 and that cleaning is necessary, thus the warning device 160 is operated.

Here, the predetermined differential pressure is set to a value of the differential pressure of the DPF when ash is accumulated to approximately 30% of the volume of a channel inside the DPF 110.

Generally, when the amount of ash accumulated in the DPF 110 is greater than approximately 30% of the volume of the channel in the DPF 110, the back pressure for the residual volume of the DPF 110 may cause the prescribed power and performance not to be output. Therefore, ash should not be accumulated to more than approximately 30% of the total volume of DPF 110.

Accordingly, the differential pressure of DPF 110 when ash is accumulated to approximately 30% of the volume of the channel in the DPF 110 is set as the predetermined differential pressure. As a result, requirement for cleaning the DPF 110 may be informed to the driver in time.

Also, the step for operating the warning device (S240) may further include calculating the amount of the generated ash depending on the engine oil consumption (S223) when the engine oil consumption is measured (S220), and comparing the amount of the generated ash with a predetermined value (S225), and the step is configured to operate the warning device 160 when the amount of the generated ash is equal to or greater than the predetermined value.

At step for calculating the amount of the generated ash (S223), the DCU 140 measures the engine oil consumption through the oil sensor 130 (S220), and the amount of the generated ash of the metal additive according to the oil consumption may be calculated depending on the concentration of the metal additive included in the consumed oil. In this case, the concentration of the metal additive may be variably set depending on the amount of the metal additive added in the engine oil.

When the amount of the generated ash is calculated by the calculation step (S223), the amount of the generated ash is compared with the predetermined value (S220), and when the amount of the generated ash is greater than the predetermined value, it is determined that ash is accumulated to more than a certain amount inside the DPF 110 and cleaning is required, thus the warning device 160 may be operated.

Here, the predetermined value may be set to the amount of ash when the ash is accumulated to approximately 30% of the volume of the channel in the DPF 110.

This is to prevent ash from being accumulated more than approximately 30% of the volume of the channel in the DPF 110. If the amount of the generated ash according to the engine oil consumption is greater than the predetermined value, it is determined that the ash is accumulated more than approximately 30% of the volume of the channel in the DPF 110, thus the warning device 160 is operated.

The warning device may be at least one of a display device and an alarm device. Namely, when the DPF 110 is determined to require cleaning, the control unit 150 may inform the driver visually and with sound that the DPF 110 needs cleaning, by operating a warning device such as a navigation apparatus, a warning light, or an alarm device.

On the other hand, the control unit 150 may perform a step for measuring the mileage of the vehicle (S230). The control unit 150 determines whether the measured mileage is equal to or greater than a predetermined distance (S235), and may operate the warning device 160 when the mileage is equal to or greater than the predetermined distance.

In this case, the predetermined distance may be set to a mileage when ash is accumulated to approximately 30% of the volume of the channel in the DPF 110 in a state in which the vehicle is driven in a normal condition.

According to the control method for informing a driver when to clean a diesel particulate filter configured as the above description, because the time when to clean a DPF is determined depending on the accumulated amount of ash, which is calculated based on the differential pressure of the DPF or engine oil consumption, the time when to clean the DPF is accurately determined regardless of a driver's driving style, driving conditions, and age of a vehicle.

Also, because the time when to clean the DPF is set to time when the accumulated amount of the ash is greater than approximately 30% of the volume of the DPF channel, the back pressure of the DPF is prevented from being increased to a level at which the prescribed power and performance of the engine may not be output, whereby the fuel efficiency is improved and the damage of the DPF is prevented.

Also, by informing a driver of the time when to clean the DPF, the driver may easily clean the DPF or replace the DPF, thus reducing the time for repairing the DPF.

Although the preferred embodiments of the present disclosure have been disclosed for illustrative purposes, those skilled in the art will appreciate that various modifications, additions and substitutions are possible, without departing from the scope and spirit of the present disclosure as disclosed in the accompanying claims.

What is claimed is:

1. A control method for informing a driver when cleaning of a diesel particulate filter (DPF) is required, the control method comprising:
informing by a control device the driver of a time to clean the DPF by operating a warning device based on at least one of a differential pressure of the DPF and engine oil consumption.

2. The control method according to claim 1 further comprising:
measuring the differential pressure of the DPF by a pressure sensor;
measuring the engine oil consumption by an oil sensor; and
operating the warning device depending on at least one of the differential pressure of the DPF and the engine oil consumption.

3. The control method according to claim 2, wherein the differential pressure of the DPF is measured when regeneration of the DPF is completed.

4. The control method according to claim 2, wherein operating the warning device comprises determining whether the differential pressure is equal to or greater than a predetermined differential pressure when the differential pressure of the DPF is measured, and
when the differential pressure of the DPF is equal to or greater than the predetermined differential pressure, the warning device is operated.

5. The control method according to claim 4, wherein the predetermined differential pressure is set to a value of a differential pressure when an ash is accumulated to approximately 30% of a volume of the DPF channel.

6. The control method according to claim 2, wherein operating the warning device comprises:
calculating an amount of generated ash depending on the engine oil consumption when the engine oil consumption is measured; and
comparing the amount of the generated ash with a predetermined value, and
wherein when the amount of the generated ash is equal to or greater than a predetermined value, the warning device is operated.

7. The control method according to claim 6, wherein the predetermined value is set to an amount of the generated ash when the ash is accumulated to approximately 30% of a volume of the DPF channel.

8. The control method according to claim 6, wherein the amount of the generated ash is calculated based on a concentration of a metal additive included in a consumed engine oil.

9. The control method according to claim 1, wherein the warning device is at least one of a display device and an alarm device.

10. A control device for informing a drive of a time to clean a diesel particular filter (DPF), comprising:
a dosing control unit configured to output at least one of a differential pressure information measured by a pressure sensor and an engine oil consumption information measured by an oil sensor; and
a control unit configured to operate a warning device based on said at least one of the differential pressure information and the engine oil consumption information.

11. A control device according to claim 10, wherein the differential pressure information is measured after a removing process of an ash or a soot in the DPF is performed.

12. The control device according to claim 10, wherein the control unit is configured to operate the warning device when a measured mileage of a vehicle by the control unit is equal or greater than a predetermined value.
